(19) United States
(12) Patent Application Publication
(10) Pub. No.: US 2010/0063881 A1
(43) Pub. Date: Mar. 11, 2010

(54) ALGORITHM FOR STORYBOARDING IN DISPLAY ADVERTISING

(75) Inventors: Arpita Ghosh, Santa Clara, CA (US); Anirban Dasgupta, Berkeley, CA (US); Hamid Nazerzadeh, Stanford, CA (US)

Correspondence Address: MPG, LLP AND YAHOO! INC., 710 LAKEWAY DRIVE, SUITE 200, SUNNYVALE, CA, 94085, US

(73) Assignee: Yahoo! Inc., Sunnyvale, CA (US)

(21) Appl. No.: 12/205,809

(22) Filed: Sep. 5, 2008

(51) Int. Cl. G06Q 30/00

(52) U.S. Cl. 705/14.54; 705/14.73

(57) ABSTRACT

Methods and system for optimally allocating ad space to advertisers on a webpage viewed by a user in a single browsing session includes identifying a plurality of advertisement stories that match the content of the webpage. An advertisement pool is generated using the identified ad stories. Each ad story in the advertisement pool includes one or more advertisement pages and is associated with corresponding ad value. An ad story from the pool of ad stories is chosen by dynamically evaluating ad value associated with each ad story in the pool based on continued surfing by the user such that the identified ad story provides the maximum ad value when rendered on the webpage. The identified ad story is scheduled for rendering on the webpage while providing relevant ad content at the webpage.

### BACKGROUND

1. Field of the Invention

The present invention relates to internet marketing, and more particularly, to optimal allocation of advertisement space for advertisers on a webpage viewed by a user during a single browsing session.

2. Description of the Related Art

Online advertising is a major source of revenue for Internet companies, with display advertising contributing a significant and growing fraction. In display advertising, the content of a webpage and the browsing history of a user are used for targeting ads. Examples of online advertising include contextual ads on search engine results pages, banner ads, pop-ups, social network advertising, advertising networks and e-mail marketing, including e-mail spam. The advantages of internet advertising are that they are cheap, far-reaching, have the ability to target specific audience and markets and provide the flexibility in obtaining advertisement space for an advertisement on a webpage.

Although internet advertising has advantages that are far-reaching, most of the on-line advertisements are not effective in reaching the intended audience. One of the reasons is that the advertisers have no knowledge or limited knowledge of the users or the users' interests. As more and more advertisers use the online advertisement tool, webpages are becoming over-populated with numerous advertisements resulting in the user becoming overwhelmed by the advertisements. This leads to the users ignoring these advertisements making the advertisements totally ineffective. Further, some of the advertisements use annoying browser tricks to capture the attention of the users. Such browser tricks tend to force the users away from the advertisement making these advertisements inefficient and ineffective. Therefore, most of on-line advertisements are either not targeted at all, or are not targeted effectively. Still further, based on the size and nature of design of some of these online advertisements, downloading of these advertisements may take longer time and, as a result, may use more screen space for rendering. The latency in rendering of the advertisement degrades a user's browsing experience.

It is, therefore, advantageous to have a tool that provides a more effective way of capturing user interest without degrading a user's browsing experience. It would also be advantageous to be able to use less download time and make efficient use of screen space on the webpage while leaving the user with rich browser experience.

It is in this context that embodiments of the invention arise.

### SUMMARY

Embodiments of the present invention provide methods and computer implemented system that enable optimal allocation of ad space to advertisers on a webpage viewed by a user in a single browsing session. The method employs a scheduler algorithm that identifies and generates a pool of advertisement stories that match contents of webpages visited by a user. For example, a query is received at the search webpage on a client and transmitted to a search engine on a server. The query is analyzed at the search engine and a webpage matching the query is identified. The scheduler algorithm available at the search engine identifies one or more advertisement stories based on the content of the webpage. Each of the advertisement stories is associated with an ad value and includes one or more advertisement pages. An advertisement story (ad story) from the pool of ad stories is selected after dynamically evaluating ad value associated with each ad story in the ad story pool based on continued surfing by the user. The selected ad story is scheduled for rendering on the webpage. The selected ad story provides maximum ad revenue while providing relevant ad content at the webpage. The scheduler algorithm may obtain additional user interactions at the rendered webpage and dynamically refine the pool of ad stories to include additional ad stories based on the user interaction that match the content of the webpage. A new ad story from the newly refined pool of ad stories is identified and scheduled for rendering at the webpage. The newly identified ad story may be a continuity of an ad story that was originally rendered on the webpage or may be a new ad story. If the ad story is new, then the existing ad story may be interrupted, if an ad story is currently being rendered at the webpage, and the new ad story scheduled in the existing ad story's place. The remainder of the advertisement pages for the interrupted ad story is discarded from the ad pool. The new ad story selected for rendering on the webpage provides maximum ad revenue while providing relevant ad content at the webpage.

It should be appreciated that the present invention can be implemented in numerous ways, such as methods or a system. Several inventive embodiments of the present invention are described below.

In one embodiment, a method for optimally allocating ad space to advertisers on a webpage viewed by a user in a single browsing session is disclosed. The method includes identifying a plurality of advertisement stories that match the content of a webpage that was identified in response to a query. An advertisement pool is generated using the identified ad stories. Each ad story in the advertisement pool includes one or more advertisement pages and is associated with corresponding ad value. An ad story from the pool of ad stories is chosen by dynamically evaluating ad value associated with each ad story based on continued surfing by the user such that the identified ad story provides the maximum ad value when rendered on the webpage. The identified ad story is scheduled for rendering on the webpage while providing relevant ad content at the webpage.

In yet another embodiment, a system, for optimally allocating ad space to advertisers on a webpage viewed by a user in a single browsing session, is disclosed. The system includes a client with a user interface configured to receive a query and transmit the query to a search engine on a server. The search engine receives the query from the client. A webpage selector at the search engine examines the query and identifies a webpage that matches the query. The search engine also includes an advertisement scheduler configured to identify one or more advertisement stories based on the query and generate an advertisement pool using the identified advertisement stories. The advertisement scheduler is further configured to dynamically evaluate ad value associated with each of the advertisement stories in the identified pool of advertisement stories and select an advertisement story from the pool of advertisement stories based on the continued surfing by the user. The identified advertisement story represents the maximum ad value when rendered on the webpage. The maximum ad value is forwarded to a webpage integrator at the search engine which integrates the ad story with the webpage returns the webpage to the client for rendering.

In yet another embodiment, a method for optimally allocating ad space to advertisers on a webpage viewed by a user in a single browsing session, is disclosed. The method includes identifying a plurality of advertisement stories from an ad network based on content of the webpage. The ad network is a repository of advertisement stories received from a plurality of advertisers and includes variety of content. Each of the plurality of advertisement stories is associated with an ad value. The advertisement stories are identified based on the ad value being greater than the ad value of an advertisement story currently rendered on the webpage. A pool of advertisement stories is generated with the identified plurality of advertisement stories. Each of the plurality of advertisement stories in the pool of ad stories is dynamically evaluated to determine an ad story with the highest ad value amongst the advertisement stories in the ad pool based on continued surfing by the user. The ad story with the highest ad value from the ad pool is scheduled for rendering at the webpage so as to provide higher ad revenue.

Thus, the embodiments of the invention provide a tool for optimal allocation of ad space to advertisers on a webpage viewed by a user. The selected ad story provides for greater return on ad revenue without compromising the quality of user's browsing experience. The embodiments enable faster downloading of the ad story thereby reducing the latency associated with regular ad story. The ad stories encompass variety of contents including text, videos, graphics, newsgroup, music, etc.

Other aspects of the invention will become apparent from the following detailed description, taken in conjunction with the accompanying drawings, illustrating by way of example the principles of the invention.

### BRIEF DESCRIPTION OF THE DRAWINGS

The invention may best be understood by reference to the following description taken in conjunction with the accompanying drawings.

FIG. 1 illustrates a high-level block diagram of a system used in optimal allocation of ad space to advertisers on a webpage, in accordance with one embodiment.

FIG. 2 illustrates a simplified block diagram of the allocation algorithm, in accordance with one embodiment.

FIG. 3A illustrates a simplified example of options considered by an allocation algorithm to determine the advertisement story for rendering on a webpage, in one embodiment of the invention.

FIG. 3B illustrates a simplified example of options considered by an allocation algorithm to determine the advertisement story for rendering on a webpage, in an alternate embodiment of the invention.

FIG. 3C illustrates a simplified example of options considered by an allocation algorithm to determine the advertisement story for rendering on a webpage, in yet another embodiment of the invention.

FIG. 4 illustrates a flow chart of process operations involved in allocating ad space to advertisers on a webpage viewed by a user, in accordance with one embodiment of the invention.

FIG. 5 illustrates a flow chart of process operations involved in optimally allocating ad space to advertisers on a webpage viewed by a user, in accordance with an alternate embodiment of the invention.

### DETAILED DESCRIPTION

Broadly speaking, the embodiments of the present invention provide methods and computer implemented systems that enable optimal allocation of ad space on a webpage viewed by a user during a single browsing session. A query is received at a server from a client through a user interface. The query is forwarded to a search engine on the server. The query is analyzed at the search engine by a webpage selector to identify a webpage from a webpage publisher matching the query. It should be understood that the webpage selector can be in the form of a code running on a server. Further, the webpage selector does not have to be integrally coupled to the search engine logic but be available to the search engine. An advertisement scheduler available at the server interacts with an ad network to identify one or more advertisement stories based on the content of the webpage. Each of the advertisement stories is associated with an ad value. The advertisement scheduler generates an advertisement pool using the identified advertisement (ad) stories. Each of the ad stories in the pool of ad stories is evaluated and an advertisement story is selected such that the selected advertisement story provides greater ad value return. The selected ad story is scheduled for rendering on the webpage.

It should be noted that there are a plurality of advertisers with a plurality of ad stories matching the content of the webpage vying for the same ad space on the webpage. By identifying a pool of ad stories relevant to the webpage that meet the ad revenue criteria, the number of ad stories to evaluate for ad space consideration is greatly reduced thereby reducing the latency associated with evaluation and rendering of the appropriate ad story on the webpage. Also, by evaluating the ad stories in the pool of ad stories, ambiguity in determining which advertiser's ad story to render is greatly reduced while maximizing total ad value. The returned ad story provides content relevant to the webpage while ensuring highest ad revenue.

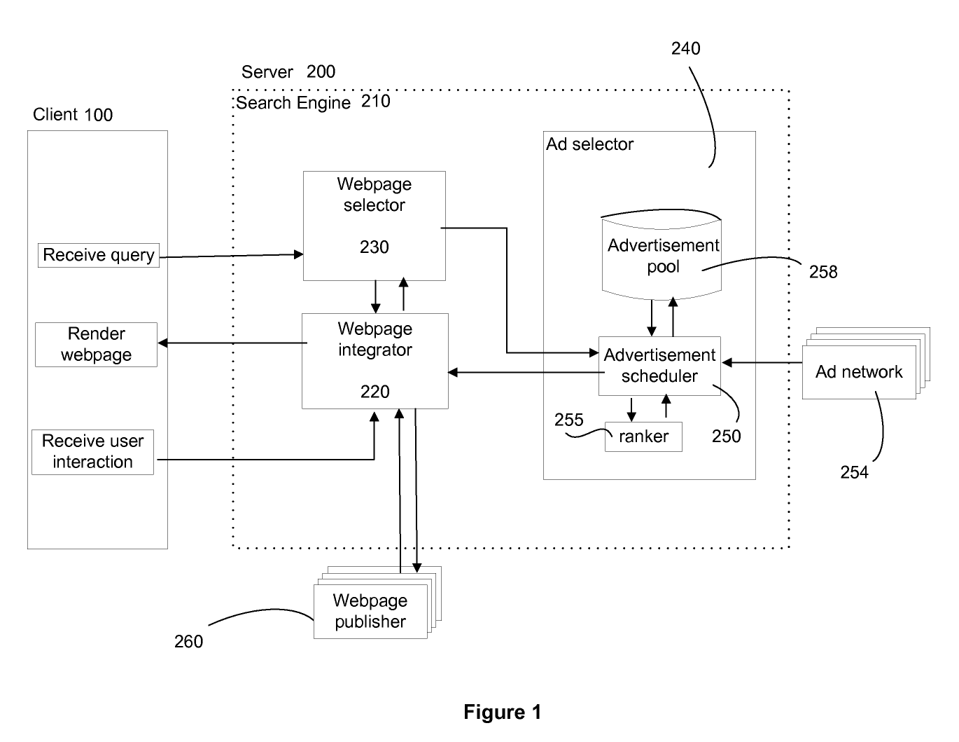

FIG. 1 illustrates a high-level block diagram of various functional elements of a computer system used in optimally allocating ad space to advertisers on a webpage viewed by a user in a single browsing session, in one embodiment of the invention. It should be understood that this is only an exemplary system, and should not be considered limiting. Other forms may also be possible, so long as the logic in processing can be carried out to optimally allocate ad space on a webpage.

The system of FIG. 1 includes a client 100 with a user interface to receive and transmit a query. The user interface is communicatively connected to a server 200 through a computer network (not shown), such as an Internet. The connection may be wired or wireless and may use any technology that allows the user interface to interact with the server. The user interface is also used to render a webpage with an advertisement story that is returned by the server in response to the query and to capture user interactions at the webpage rendered at the client 100.

The server 200 includes a search engine to receive the query from the client 100. A webpage selector 230 at the search engine 210 processes the query. The webpage selector 230 may be integrated within the search engine 210 or may be distinct from the search engine 210 and may be available to the search engine 210 for processing. The webpage selector 230 is configured to receive and analyze the query and to interact with a webpage publisher 260 available to the search engine 210 to identify a webpage that matches the query. The webpage publisher 260 is a repository of webpages published by a plurality of publishers. The identified webpage is forwarded to a webpage integrator 220 for integrating with any advertisement story available for the webpage. The webpage integrator 220 may be integrated within the search engine 210 or webpage selector 230 or may be distinct and may be available to the search engine 210 for processing.

The search engine 210 includes an ad selector module 240 to select one or more advertisement stories that match the content of the selected webpage. In order to identify the appropriate advertisement stories, the ad selector 240 includes an advertisement scheduler module 250 with a scheduler algorithm that interacts with an ad network 254 to obtain a plurality of advertisement stories from a plurality of advertisers. The ad network 254 may be accessed through a network (not shown). The ad network 254 is a repository of advertisement stories from a plurality of advertisers that are updated dynamically. The advertisement stories may be of varied content and style. A plurality of ad parameters may be used to store the advertisement stories within the ad network 254. Some of the ad parameters may include advertisement (ad) story ID, advertiser ID, ad topic, ad keywords, ad length, ad content type, ad specification, ad restriction, ad value.

The ad selector 240 may be integrated within the webpage integrator 220 and webpage selector 230 or may be distinct and be available to the webpage integrator 220 and webpage selector 230. The advertisement (ad) scheduler 250 interacts with the webpage selector 230 to determine the content within the selected webpage in order to select one or more ad stories that match the content of the webpage. The ad scheduler 250 identifies and retrieves one or more ad stories from the ad network 254 matching the content of the selected webpage. The retrieved ad stories are placed into an advertisement (ad) pool 258. The ad pool 258 may be considered as a repository of ad stories retrieved from the ad network with content matching the content of the webpage and is a subset of the ad repository 254. The retrieved ad stories are evaluated to determine the ad value associated with each ad story. The ad scheduler 250 then selects an ad story from the ad pool 258 by comparing the ad value of each of the ad stories in the ad pool 258 and selecting the one with the highest ad value in the ad pool. When more than one ad story has the same highest ad value, a ranker algorithm 255 available at the ad selector 240 is used to rank and prioritize the ad stories with the same ad value. The ranker is a software module that may be integrated within the ad scheduler 250 or may be distinct and available to the ad scheduler 250 for ranking and prioritizing the ad stories within the ad pool 258. The ranker uses one or more ranking parameters to rank and prioritize the ad stories. The ad scheduler 250 then selects an ad story from the plurality of ad stories with common higher ad value based on the relative ranking. The selected ad story is then scheduled for rendering at the webpage. In order to schedule the ad story for rendering, the ad story is forwarded to the webpage integrator 220 for integrating with the webpage.

The webpage integrator 220 is configured to receive and integrate the selected ad story into the selected webpage. The integrated webpage is then forwarded to the client 100 for rendering at the user interface in response to the query. The webpage integrator 220 and webpage selector 230 are software modules available at the search engine 210. The webpage integrator 220 may be integrated with the webpage selector 230 or may be distinct and is configured to receive the webpage from the webpage selector for integrating the selected ad story. The integrated webpage is then forwarded to the client 100. The returned webpage is then rendered on the user interface at the client 100.

It should be noted that in order for the webpage to render the ad story at the client, the webpage should be configured for receiving and rendering of the ad story. This is accomplished by the webpage publisher signing onto the ad network 254. Upon signing onto the ad network 254, the webpages created by the publisher are enabled for receiving and rendering ad stories. In some instances, the publisher may decide not to enable some webpages for rendering ad stories. In this case, the webpage may include a parameter, such as a flag, that could be set to disable rendering of the ad stories. These disabled webpages will not be considered for rendering ad stories.

Upon rendering the webpage with the ad story, the user may navigate to a subsequent webpage from the rendered webpage through links available within the webpage. When the user navigates to the subsequent webpage, the current ad story may continue to render or a new set of ad stories are considered for rendering on the newly navigated (subsequent) webpage, provided the webpage is enabled for rendering ad stories. As mentioned above, the publisher for the newly navigated webpage must have signed onto the ad network 254 in order to receive and render any ad story at the subsequent webpage.

In one embodiment, when the user shows interest to navigate to a subsequent webpage, the user interaction is captured at the webpage selector 230. The webpage selector 230 interacts with the webpage publisher 260 to determine the subsequent webpage. The ad scheduler 250, in turn, interacts with the webpage selector 230 to determine the content of the subsequent webpage. If the publisher of the subsequent webpage is signed onto the ad network 254, the ad scheduler 250 interacts with the ad network 254 to identify one or more ad stories that match the content of the subsequent webpage. The identified ad stories for the subsequent webpage are added to the current pool of ad stories (pool) 258. The original set of ad stories is retained in the pool 258. As the ad stories in the pool 258 were selected based on the relevancy to the content of the original webpage and are indicative of user interest in those ad stories, these ad stories are still retained in the pool 258 and the new ad stories for the subsequent webpage are simply added into the pool 258. Upon updating the pool 258 with the new ad stories, the ad scheduler 250 dynamically evaluates the ad value of each ad story within the pool 258 to determine an ad story with the highest ad value. The ad story with the highest ad value is selected and scheduled for rendering with the subsequent webpage.

As mentioned earlier, during the evaluation process, it may be determined that more than one ad story has the same ad value. In such a case, a ranker algorithm 255 is used to rank and prioritize the ad stories so as to determine the ad story with the highest rank and highest value in the pool 258. The ad story with the highest rank and highest ad value is selected and scheduled for rendering at the subsequent webpage. The selected ad story is forwarded to the webpage integrator 220 for integrating with the subsequent webpage.

In one embodiment, the ranker algorithm 255 is used to rank and prioritize the ad stories during the generation of the ad pool 258. In this embodiment, when the ad scheduler 250 identifies and retrieves the ad stories from the ad network 254, the ranker algorithm automatically ranks and prioritizes the ad stories and the ranked ad stories are then stored in the pool 258 in the order of their ranking based on the content of the webpage. In this embodiment, when the ad scheduler evaluates the ad stories, the ad story with the highest ad value and top rank is automatically selected and scheduled for rendering at the new webpage. When new ad stories are identified and added to the pool 258, the ranker ranks all the ad stories including the ones that are currently added to the pool 258 to determine the rank and priority of each of the ad stories within the ad pool 258.

If the webpage currently rendered at the user interface already includes an ad story contained therein, the ad story of the webpage is included in the list of ad stories within the pool 258. When the user navigates to a subsequent webpage, the ad scheduler 250, during the evaluation process for determining which ad story to schedule for rendering in the subsequent webpage, may determine that the ad story currently rendered on the webpage is ranked higher than all the remaining ad stories in the pool 258. In this instance, the current ad story is scheduled for rendering at the subsequent webpage navigated by the user. As the ad story contains one or more advertisement pages, a subsequent advertisement page from the current ad story is scheduled for rendering at the subsequent webpage.

In some instance, the webpage currently rendered at the user interface may not include any ad story. This may be due to the fact that the publisher of the webpage may not have signed onto the ad network 258 or the webpage may not be enabled for receiving and rendering ad stories. When the user navigates to a subsequent webpage from the current webpage, the ad scheduler 250 determines if the subsequent webpage is enabled to receive and render ad stories. If the webpage is enabled for receiving and rendering ad stories, the ad scheduler 250 identifies one or more ad stories matching the content of the subsequent webpage, generates the advertisement pool (pool) 258 with the identified ad stories, selects one of the ad stories from the ad pool 258 and schedules the selected ad story for rendering on the subsequent webpage. The selected ad story may be based on its ad value and the relative rank amongst the ad stories in the pool 258. In this case, the first page of the identified ad story is rendered at the subsequent webpage.

In the case where the current webpage includes an ad story, the ad scheduler 250 may determine that the ad story that is being rendered on the current webpage is not the optimal ad story to render for the subsequent webpage. In such a case, the ad scheduler 250 evaluates the ad stories in the pool 258 to determine an ad story that is optimal for rendering at the subsequent webpage. Once an optimal ad story is determined, the ad scheduler 250 preempts the current ad story and schedules the new ad story for rendering at the subsequent webpage. In this case, the first page of the new ad story is scheduled for rendering at the subsequent webpage and the remainder of advertisement pages of the preempted ad story is discarded from the pool 258. The discarding of the preempted ad story might be due to the fact that the advertiser to whom the preempted ad story belongs is no longer interested in showing his ad to the user due to the fact that the user has lost interest in his ad story based on the preemption. Once the ad story is discarded, the same ad story may be reconsidered during subsequent ad pooling. When this ad story is reconsidered during subsequent ad pooling based on user interaction, the ad story is considered in its entirety and not from the point where the preemption occurred.

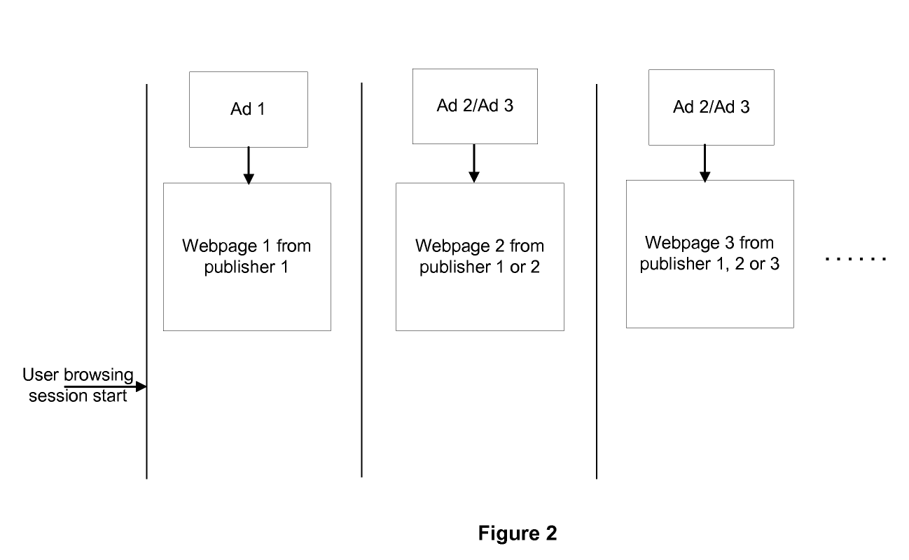

FIG. 2 illustrates the ad story options available to the ad scheduler during a user's browsing session, in one embodiment of the invention. A query from a user is received at the webpage integrator on a server. The webpage integrator identifies a webpage, webpage 1, from a publisher, publisher 1, which matches the query. If the publisher is part of an ad network, an ad story, Ad 1, from a pool of ad stories is identified by an ad scheduler as being optimal for rendering at the webpage 1. Ad 1 may include an ad story with 3 pages at $5.00 per page impression. Based on the ad scheduler's evaluation, the first page of Ad 1 is scheduled for rendering at the webpage 1. When a user navigates to a new webpage, the webpage selector interacts with webpage publisher to identify the new webpage, webpage 2. Webpage 2 may be published by the same publisher, publisher 1, or may be published by a different publisher, publisher 2. In any case, if the publisher of webpage 2 is signed onto the ad network and webpage 2 is enabled to receive ad story for rendering, then the ad scheduler dynamically evaluates the ad stories in the pool to determine an ad story that matches the content of webpage 2. In this case, the remainder of ad story, Ad 1, within the pool, is also considered during the ad scheduler's evaluation process. In addition to the existing ad stories within the ad pool, the ad scheduler may retrieve additional ad stories from the ad network that match the content of webpage 2 and update the ad pool with these additional ad stories so that these additional ad stories may also be considered during the dynamic evaluation of ad stories. It should be noted here that ad stories are constantly being updated dynamically into the ad network from a plurality of advertisers and, as a result, additional ad stories may become available for consideration by the ad scheduler during the evaluation process.

Upon updating the ad pool with additional ad stories, the ad scheduler determines that the current ad story, Ad 1, is not optimal for rendering on webpage 2. Instead, Ad 2 with a 1 page story at $10.00 per page impression and Ad 3 with a 6 page story at $8.00 per page impression provide better ad return. As a result, Ad 1 is preempted and the remainder of advertisement pages associated with Ad 1 are discarded from the ad pool. As shown in FIG. 2, the remaining 2 advertisement pages of Ad 1, advertisement pages 2 and 3 are discarded and 1 page from Ad 2 and 6 pages of Ad 3 are considered during the evaluation to determine which ad story should be scheduled for rendering at webpage 2.

The evaluation process includes a scheduler algorithm within the ad scheduler that is based on the probability of a user continuing the current browsing session. According to the scheduler algorithm, if ‘β’ is the probability that the user will continue the browsing session, then (1−β) will be the probability that the user will exit the browsing session after the current webpage. The scheduler algorithm evaluates the total expected ad value that could be obtained by interrupting the current story (Vₜ₋₁) and scheduling all the stories with higher average value (Vₜ). If this value is greater than the value obtained by continuing with the current story, then the current story will be interrupted and a best new story will be scheduled. A sample pseudo-code used by the scheduler algorithm is provided in Table A.

TABLE A
Algorithm G:

```
  At each time t:
  If no job is in progress,
    Schedule a job with the highest per-unit value.
  Otherwise, let s be the current job.
    Let Aₜ be the set of all jobs with per-unit value higher than vₛ.
    If vₛ < (1− β)V(Aₜ) then
      Preempt s
      Schedule a job with the highest per-unit value.
    Otherwise, continue with the current job.
(wherein a job is an ad story and per-unit value is the per impression value
of the ad story).
```

Still referring to FIG. 2, when a user continues the current browser session by navigating to a third webpage, webpage 3, using links within webpage 2, the ad scheduler dynamically evaluates the ad stories currently available in the ad pool for webpage 3 to determine the optimal ad story for rendering on webpage 3. Webpage 3 may be published by any one of publishers, publisher 1, publisher 2 or publisher 3, that are signed into the ad network. The ad scheduler may identify and retrieve additional ad stories from the ad network based on the content of webpage 3 and based on additional ad stories available at the ad network due to real-time dynamic update of ad stories to the ad network. The additional ad stories identified by the ad scheduler are updated to the ad pool and are considered during the evaluation process for determining the optimal ad story for webpage 3. As a result, Ad 2 with 1 page at $10.00 per page impression and Ad 3 with 6 pages at $8.00 per page impression are the ad stories considered by the algorithm in determining which of the two ad stories should be considered for rendering at webpage 3. Upon evaluation, the ad story with the optimal per page ad value will be considered by the scheduler algorithm for rendering at webpage 3. If, in webpage 2, ad story Ad 2 was rendered, then Ad 2 should not be an option for webpage 3 as the ad story, Ad 2, was already rendered with webpage 2. However, Ad 2 will become an option for webpage 3 if Ad 2 was identified and retrieved from the ad network as an additional ad story during the evaluation process for determining the optimal ad story for webpage 3, since Ad 2 includes just one page. As a result, Ad 2 is added to the ad pool and is considered as an option when evaluating the relevant ad story for webpage 3.

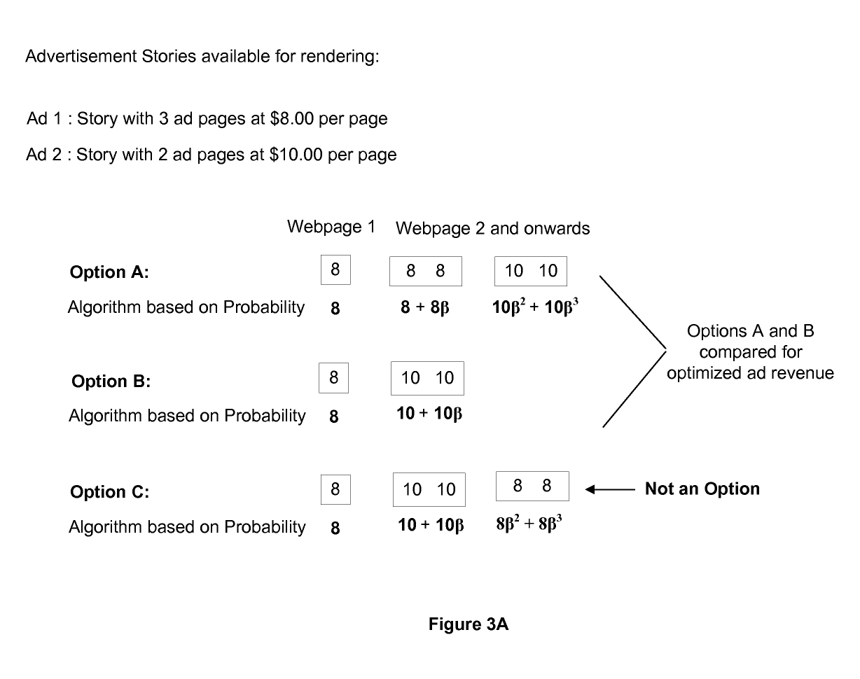

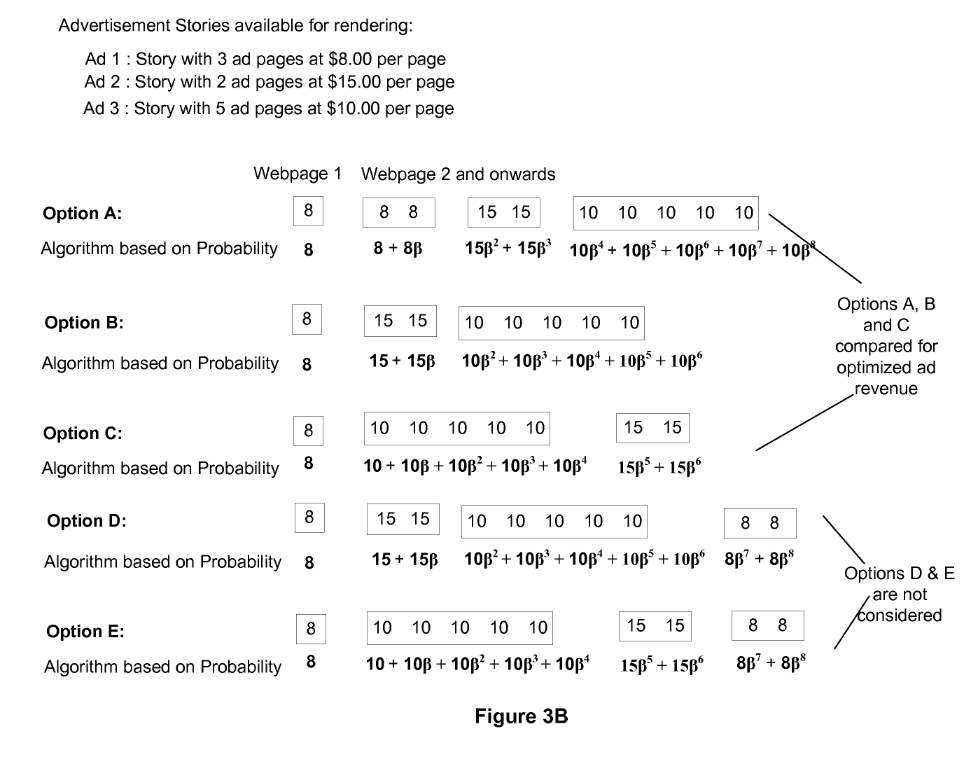

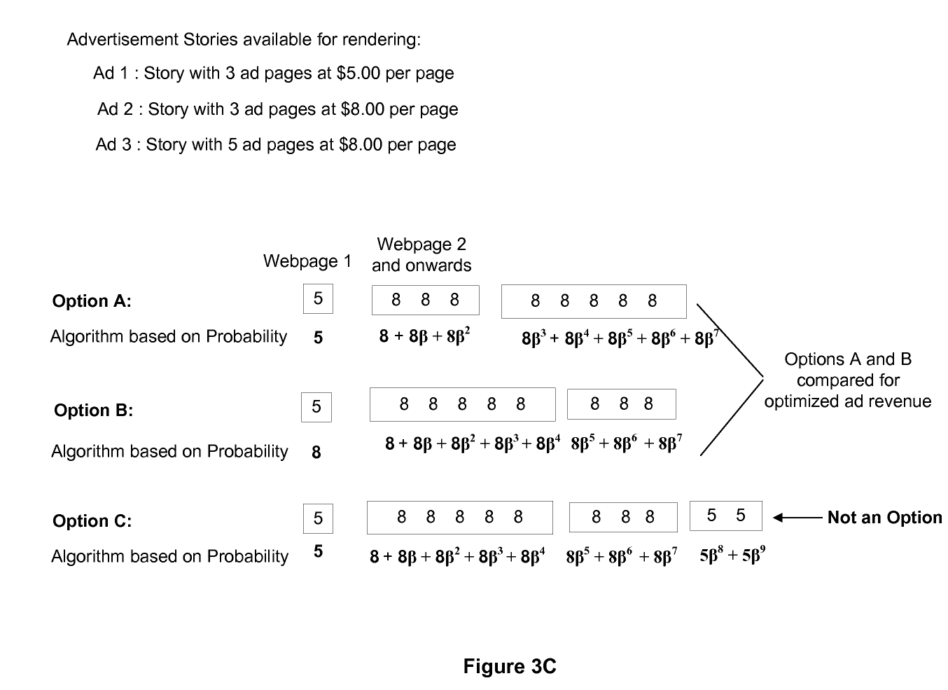

FIGS. 3A through 3C illustrate some of the algorithmic options available at the ad scheduler during the evaluation process. As illustrated in FIG. 3A, a webpage, webpage 1, with an ad story, Ad 1, is rendered on the webpage in response to a query from a user. Ad 1 includes a story with 3 ad pages at $8.00 per page impression. When the user navigates to a second webpage, usually from links available at webpage 1, the scheduler algorithm available at the ad scheduler evaluates the options that are currently available. In one embodiment, the scheduler algorithm identifies only ad stories with per page ad value that is greater than the per page ad value of the one that is currently rendered on the webpage. In this embodiment, the scheduler algorithm identifies an ad story, Ad 2, with 2 pages at $10.00 per page impression matching the content of webpage 2. As a result, Ad 2 is added to the ad pool. The ad pool already contains Ad 1 as an option as a ad page from Ad 1 is currently rendered on webpage 1. The content of Ad 1 may or may not match the content of webpage 2. Even if the content does not match the content of webpage 2, Ad 1 is still considered as Ad 1 was considered relevant to webpage 1. It should be noted that additional ad stories that were considered for webpage 1 that are currently in ad pool will also be considered as a valid option for webpage 2 even though the content of these ad stories might not relate to the content of webpage 2 but were related to the content of webpage 1. The reason for this consideration is due to the fact that the advertisers of these ad stories might still be interested in the user.

The ad scheduler evaluates the options available at the ad pool to determine an ad story that provides highest ad value for the webpage 2. As shown in FIG. 3A, a second ad story matching the contents of the webpage is identified from the ad network and added to the ad pool. For simplicity, the ad stories that are in the ad pool that are considered as options for webpage 2 are illustrated in FIG. 3A as Ad 1 and Ad 2. In reality, it should be noted that the ad pool may include a plurality of ad stories from a plurality of advertisers with content of each ad story matching the content of webpage 2 and the ad value associated with each ad story being greater than the ad value of the currently rendered ad story. The ad story with the optimal ad value is selected by evaluating the ad values using the scheduler algorithm based on the probability of the user continuing the browsing session. Accordingly, if ‘β’ is the probability that the user will continue the browsing session, the scheduler algorithm determines the expected total ad value for each option available to pick the option with maximum expected total ad value.

As shown in FIG. 3A, the three options that are available are options A, B, and C. In Option A, the expected total ad value is calculated based on allowing the current ad story to complete and then rendering the ad story with the highest ad value based on the probability that the user continues the browsing session for that long. Thus, the total expected ad value for webpage 2, as calculated for option A=8+8β+10β²+10β³, not considering the first page of Ad 1, which has already been rendered on webpage 1, but only considering the remaining two ad pages of Ad 1 and the two ad pages of Ad 2. As the chances of a user continuing the browsing session for a long time is less, the ad value for the corresponding time period is also less. Consequently, the ad value is expressed in terms of a geometric progression of the probability. Similarly, with option B, the total expected ad value for webpage 2=10+10β wherein the ad story with the highest ad value is considered. Option C includes preempting Ad 1, rendering both pages from the ad story with the highest ad value, Ad 2, and then continuing rendering the remaining ad pages from the preempted ad story, Ad 1. Option C is not considered by the scheduler algorithm as the scheduler algorithm automatically discards remaining ad pages from any ad story that has been preempted. In one embodiment, the scheduler algorithm only considers ad stories with ad values greater than the ad value of the ad story currently rendered on the webpage. In this embodiment, the current ad story will be preempted and automatically discarded during the evaluation process. Based on the above two options, the scheduler algorithm picks the ad story with the highest ad value for webpage 2, option B. Upon selecting the ad story for webpage 2, the ad scheduler preempts the ad story, Ad 1, that was running on webpage 1, discards the remaining ad pages for the preempted ad story, Ad 1, from the ad pool and schedules the advertisement pages of the selected ad story, Ad 2, for rendering by forwarding the ad story to a webpage integrator which integrates the identified ad story with the webpage 2. The integrated webpage is returned to the client in response to the query.

FIG. 3B illustrates an alternate algorithmic option available at the ad scheduler during the evaluation process, in one embodiment of the invention. In this embodiment, to begin with, the ad pool includes an ad story with 3 ad pages at $8.00 per page impression that is considered as optimal choice for rendering the ad page for webpage 1. The ad pool may include additional ad pages (not shown) that may have been considered for rendering on webpage 1 prior to the ad scheduler selecting Ad 1. As illustrated in FIG. 3B, when the user navigates to webpage 2, the ad pool includes 2 additional ad stories for considering rendering on webpage 2. As a result, the ad pool includes the existing Ad 1 with a story with 2 remaining ad pages at $8.00 per page impression, Ad 2 with a story having 2 ad pages at $15.00 per page impression and option 3 with a story having 5 ad pages at $10.00 per page impression. The scheduler, during the evaluation considers option A, wherein the remaining ad pages from Ad 1 are rendered prior to rendering the ad story with the highest ad value, Ad 2, and finally considering Ad 3 with 5 ad pages; option B, wherein the ad story with the highest ad value, Ad 2, is considered for rendering after which the next highest ad valued ad story, Ad 3 is considered; and option C, wherein ad pages from Ad 3 is considered for rendering followed by ad pages from Ad 3, as these are the two ad stories with higher ad value than the ad value of Ad 1 that is currently rendered on webpage 1. As mentioned with respect to FIG. 3A, options D and E are not valid options as the ad scheduler discards the remaining ad pages from Ad 1 when it is preempted. In one embodiment, the scheduler algorithm selects the ad story with the highest per ad page impression value from all the ad stories in the pool. In this embodiment, based on the evaluation, option B is picked over the other options as the next immediate ad page that is considered for rendering has the highest ad value per ad page impression.

FIG. 3C illustrates yet another alternate algorithmic option available at the ad scheduler during the evaluation process, in one embodiment of the invention. As illustrated, webpage 1 is currently rendered with an ad page from an ad story, Ad 1. Ad 1 has an ad story with 3 ad pages at $5.00 per ad page impression. As the user navigates to a second webpage, webpage 2, the scheduler algorithm identifies additional ad stories that match the content of webpage 2. As shown, Ad 2 with an ad story having 3 ad pages at $8.00 per ad page impression, and Ad 3 with an ad story having 5 ad pages at $8.00 per ad page impression are identified and added to the ad pool. During evaluation, the scheduler algorithm determines the various options available for evaluation. As shown, the scheduler algorithm considers two options, Options A and B. In Option A, the expected total ad value is calculated based on allowing the current ad story to be preempted, rendering the ad story with the highest ad value based on the probability that the user continues the browsing session for that long. In this embodiment, Ad 2 and Ad 3 have ad pages with the same ad value but of different story length. The total expected ad value for webpage 2, is calculated for option A based on preempting the current ad story and rendering the ad pages from Ads 2 and 3 and is found to be=8+8β+8β²+8β³+8β⁴+8β⁵+8β⁶+8β⁷, not considering the first page of Ad 1, which has already been rendered on webpage 1, but only considering the ad pages from Ad 2 and Ad 3. Similarly, in Option B, the expected total ad value is calculated based on preempting the current ad story and then rendering the ad pages from Ad 2. Thus, the total expected ad value for webpage 2, as calculated for option B=8+8β+8β²+8β³+8β⁴+8β⁵+8β⁶+8β⁷ not considering the first page of Ad 1, which was already rendered on webpage 1, but only considering the ad pages from Ad 2. As can be seen, the total expected ad value is the same for both the options. In this embodiment, the scheduler algorithm will weigh in on both the options and consider continuing the current ad story and choose option A over option B as option A is of shorter length. This may be due to the fact that it is not known how long the user will continue the browsing session and so the scheduler algorithm picks the ad story with the shorter story line. As mentioned earlier, option C is not an option at this point.

As can be seen, the scheduler algorithm considers all the options available and picks the one with the highest ad value per ad page impression and when the ad values of options are the same picks the ad story with a shorter story line. It should be noted that in all the embodiments discussed above, the ad value per ad page impression remains constant for all the ad pages within a given ad story. The ad value for each ad page within an ad story need not be the same. In one embodiment, the ad value of each ad page within an ad story is distinct. In this embodiment, during the evaluation process, the scheduler algorithm considers the ad value of an ad page that is currently being considered for rendering, such as an ad page immediately following a current ad page of an ad story that is currently being rendered or the first page of an ad story that is not yet rendered, to determine the next highest ad value per ad page impression.

In each of the embodiments described above, it should be noted that when considering an ad story as an option for a webpage, it is essential to consider any restrictions and other requirements of the ad story itself. Thus, when an ad story is considered as an option for including in the ad pool, the content of the ad story should not only match the content of the webpage and also any restrictions and requirements of the ad story must also be considered. Further, in the above embodiments, the scheduler algorithm considers that during the course of selection of subsequent webpages, no other advertisers are vying for the ad space on the subsequent webpages and the user's interest has not changed. In reality, hundreds of advertisers may be vying for the ad space and the user's interest may be changing. The above embodiments have been explained in detail with respect to a single user. The same scheduler algorithm may be extended to consider a plurality of users.

It should be noted that the ad stories mentioned herein may be of different types based on the time limit associated with rendering of the ad story. Typically, ad stories are associated with two different models—a deadline model and a no-deadline model. In a deadline model, the ad stories have a sharp deadline within which the ad stories have to be rendered. Accordingly, in the deadline model, the ad stories have to be rendered immediately upon arrival at an ad repository or within a short pre-set period of time. In a no-deadline model, the ad stories can be rendered at any time after they arrive at the ad repository. In the embodiments of the invention described herein, the ad stories associated with the no-deadline model are considered.

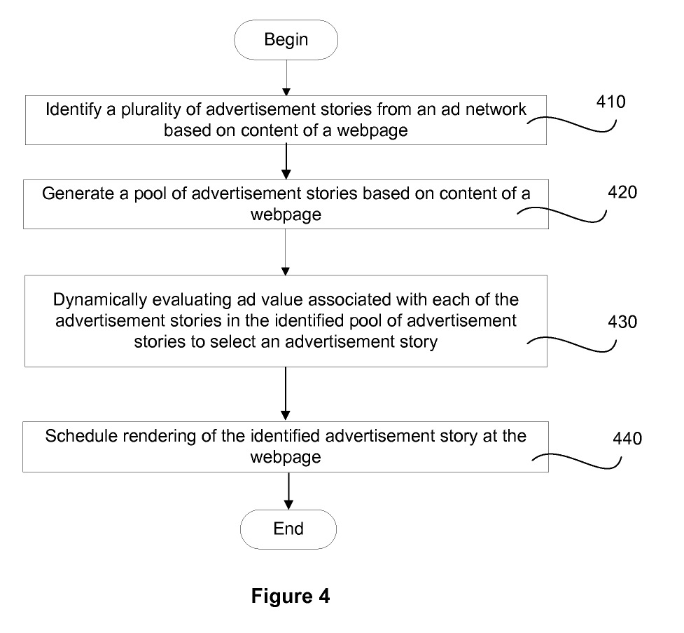

With the above detailed description in mind, a method for optimally allocating ad space to advertisers on a webpage viewed by a user in a single browsing session will now be described with respect to FIG. 4. The method begins with the generation of a pool of advertisement stories based on content of a webpage, as illustrated in operation 410. A query from a user is received at a search engine on the server. A webpage selector at the search engine receives the query and interacts with a webpage publisher module to identify a webpage for rendering in response to the query. An ad selector module available at the search engine interacts with the webpage selector to determine the content of the selected webpage. The ad selector module includes an ad scheduler with a scheduler algorithm that interacts with an ad network to identify one or more ad stories that match the content of the webpage. An ad pool is generated by including the identified ad stories. The ad scheduler then dynamically evaluates ad value associated with each of the ad stories in the generated pool of ad stories. An ad story is selected based on the ad value, as illustrated in operation 420. The ad story may be selected based on the highest ad value, in one embodiment. In another embodiment, the ad story may be selected based on the highest priority. The selected ad story may include one or more ad pages. The selected ad story is scheduled for rendering on the webpage, as illustrated in operation 430. This is done by forwarding the selected ad story to a webpage integrator that integrates the selected ad story with the webpage that is received from the webpage selector. The integrated webpage is forwarded to the client for rendering. If the selected ad story is an ad story whose ad pages are currently being rendered, then the ad story may continue rendering the remaining of the ad pages of the selected ad story in the current webpage. If the selected ad story is a new ad story whose ad pages have not yet been rendered on the webpage, then the first page of the ad story may be scheduled for rendering at the webpage. The method concludes with the scheduled rendering of the webpage with the ad story.

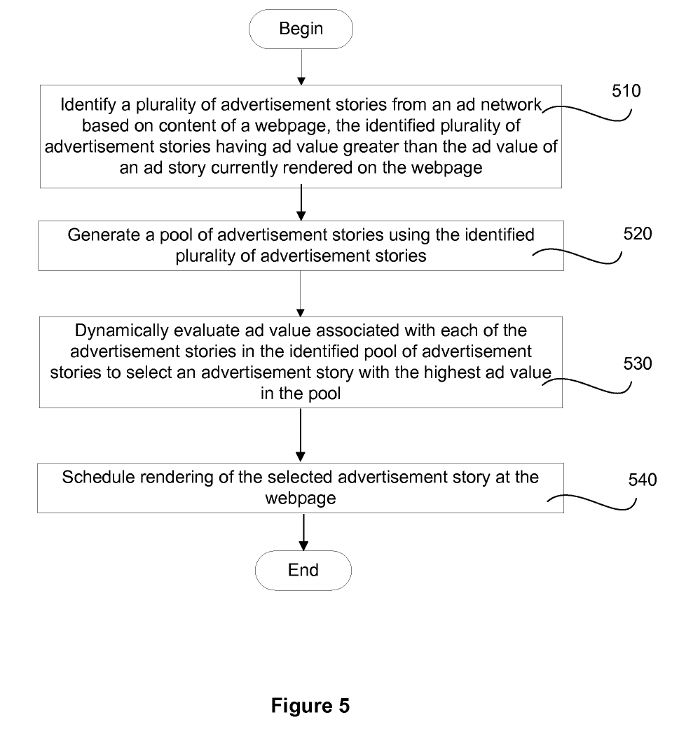

FIG. 5 illustrates a flow chart of operations involved in optimally allocating ad space to advertisers on a webpage viewed by a user in a single browsing session, in an alternate embodiment. The method begins at operation 510 when a plurality of advertisement stories are identified from an ad network based on content of a webpage. A query from a user is received at a search engine on a server. The query is analyzed at the search engine and a webpage selector within the search engine interacts with webpage publisher to identify a webpage with content that matches the query. An ad scheduler within an ad selector module available at the search engine queries the webpage selector to determine the content of the webpage and interacts with an ad network to identify a plurality of ad stories that match the content of the webpage. The ad scheduler generates a pool of the identified ad stories, as illustrated in operation 520. The ad scheduler dynamically evaluates ad value associated with each of the ad story to determine an ad story with the highest ad value in the pool, as illustrated in operation 530. Each of the plurality of ad stories is associated with an ad value and is made up of one or more advertisement pages. The ad value of an ad story is based on the ad value associated with each advertisement page within the ad story which may be constant or may vary based on the ad value associated with each advertisement page of the ad story. When the ad value varies with each advertisement page within an ad story, a current ad value of the ad story is the ad value of a corresponding advertisement page of the ad story that is currently being considered for rendering. The ad scheduler considers the current ad value associated with an ad story during evaluation. The advertisement page currently considered for rendering may be a first page of an ad story that is not yet rendered on a webpage or a consecutive advertisement page of an ad story that is already being rendered on a webpage. During evaluation, the ad scheduler identifies an ad story corresponding to an advertisement page being considered for rendering with the highest ad value. The process concludes with the identified ad story scheduled for rendering at the webpage, as illustrated in operation 540. This is enabled by retrieving the current advertisement page from the ad story that was considered during evaluation and forwarding the ad page to a webpage integrator to integrate with the identified webpage. The integrated webpage is returned to the client for rendering in response to the query. The process continues when the user continues on with the browsing session with a refined pool of ad stories and reevaluation of the ad stories within the refined pool to identify the ad story with the highest ad value. The refined pool may include additional ad stories corresponding to the subsequent webpage that the user is navigating in the current user session.

Some of the ad parameters associated with an ad story may include advertisement (ad) story identification (ID), ad topic, ad keywords, ad length, ad content type, ad description, ad restriction, ad value. Some of the probability parameters may include one or more of user ID, time of day, user demographic, surfing habit of the user, length of the surfing session, location of the user and age group. The ranking parameters used to rank and prioritize two or more ad stories include any one or more of ad story identification (ID), advertiser ID, ad value, priority, ad length, ad content, ad description and ad restriction.

Thus, embodiments of the invention provide a tool to optimally allocate ad space to advertisers on a webpage within a single browsing session of a user thereby optimally reaching to the users without impacting a user's browsing experience. The tool allows an advertiser to market their product or service effectively through ad stories. These ad stories allow the advertiser to market their products and services over an extended period of time while enabling a user to have a rich surfing experience. Since the ad story is delivered one advertisement page at a time, the latency associated with downloading an entire ad story is avoided. The tool allows the user to enjoy a de-cluttered webpage of content-rich information while providing an advertiser with exclusive attention of a user thereby enhancing effective marketing.

It will be obvious, however, to one skilled in the art, that the present invention may be practiced without some or all of these specific details. In other instances, well known process operations have not been described in detail in order not to unnecessarily obscure the present invention.

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention could employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can thereafter be read by a computer system. The computer readable medium can also be distributed over a network-coupled computer system so that the computer readable code is stored and executed in a distributed fashion.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for optimally allocating ad space to advertisers on a webpage viewed by a user in a single browsing session, comprising:
generating a pool of advertisement stories with content based on content of the webpage, the pool of advertisement stories identified from an ad network, the ad network being a repository of advertisement stories from a plurality of advertisers that include a variety of content;
selecting an advertisement story from the pool of advertisement stories upon dynamically evaluating ad value associated with each of the advertisement stories in the identified pool of advertisement stories based on continued surfing by the user; and
scheduling a rendering of the selected advertisement story at the webpage, the selected advertisement story providing higher ad revenue while providing relevant ad content at the webpage,
wherein each of the advertisement stories in the pool of advertisement stories include one or more advertisement pages with each advertisement page associated with the ad value.

2. The method of claim 1, wherein the pool of advertisement stories dynamically changes based on dynamic arrival of advertisement stories from a plurality of advertisers and on surfing strategy adopted by the user.

3. The method of claim 2, wherein the surfing strategy includes one of continued surfing.

4. The method of claim 1, wherein generating a pool of advertisement stories further including,
identifying one or more advertisement stories with content that match the content of the webpage;
when an advertisement story is currently rendered on the webpage,
determining one or more of the identified advertisement stories with ad value greater than the ad value of the advertisement story that is currently rendered on the webpage; and
automatically discarding one or more advertisement stories with ad value less than the ad value of the currently rendered advertisement story.

5. The method of claim 1, wherein evaluating ad value further including,
determining a probability of continued surfing by the user; and
identifying an advertisement story from the generated pool of advertisement stories with a maximum ad value by comparing the ad value of each of the advertisement stories in the identified pool of advertisement stories based on the probability of continued surfing by the user.

6. The method of claim 5, wherein the identified pool of advertisement stories includes the advertisement story currently rendered on the webpage.

7. The method of claim 6, wherein scheduling the rendering of the selected advertisement story includes scheduling rendering of a first advertisement page of the selected advertisement story.

8. The method of claim 6, wherein scheduling the rendering of the selected advertisement story further including,
preempting the advertisement story currently rendered on the webpage; and
scheduling a first advertisement page from the identified advertisement story, wherein the ad value of the identified advertisement story is greater than the ad value of the currently rendered advertisement story.

9. The method of claim 8, wherein preempting further including discarding the remainder of the advertisement pages of the advertisement story currently being rendered on the webpage from the pool of advertisement stories.

10. The method of claim 6, wherein scheduling the rendering of the selected advertisement story is to continue the currently rendered advertisement story by scheduling a subsequent advertisement page from the currently rendered advertisement story for rendering.

11. The method of claim 4, further including using a ranking algorithm with a plurality of ranking parameters to rank and prioritize two or more identified advertisement stories with ad values of each of the identified advertisement stories being the same, wherein a higher ranked advertisement story is used in rendering on the webpage.

12. The method of claim 11, wherein the ranking parameters includes one or more of advertisement story ID, advertiser ID, ad value, priority, ad length, ad content, ad description and ad restriction.

13. The method of claim 4, wherein the probability of continued surfing is based on one or more parameters associated with the user, the probability parameters including one or more of user ID, time of day, user demographic, surfing habit of the user, length of the surfing session, location of the user and age group.

14. The method of claim 4, wherein the discarded lower priced advertisement stories are considered for generating a subsequent pool of advertisement stories based on content of the webpage, the discarded lower priced advertisement stories including all of the advertisement pages of one or more of the interrupted advertisement stories.

15. The method of claim 5, wherein upon completing rendering the higher ad valued advertisement story, continuing rendering an advertisement story of next higher ad value based on the probability of user's continued surfing.

16. The method of claim 1, wherein the ad value for each advertisement page within an advertisement story being distinct and wherein the dynamic evaluation of ad value associated with an advertisement story based on ad value of a corresponding advertisement page of the advertisement story currently being considered for rendering.

17. A system for optimally allocating ad space to advertisers on a webpage viewed by a user in a single browsing session, comprising:
a client configured to generate a query, render the webpage, capture user interaction at the webpage;
a server with a search engine configured to receive the query and user interaction from the client and identify one or more results for the query, the search engine including
an advertisement scheduler configured to,
generate an advertisement pool with one or more advertisement stories based on content of a webpage with content matching the query;
select an advertisement story from the pool of advertisement stories upon dynamically evaluating ad value associated with each of the advertisement stories in the identified pool of advertisement stories based on continued surfing by the user; and
return the selected advertisement story with the webpage for rendering at the client in response to the query,
wherein each of the advertisement stories in the pool of advertisement stories include one or more advertisement pages with each advertisement page associated with an ad value and wherein the webpage is receptive to publishing advertisement stories.

18. The system of claim 17, wherein the system further includes an ad network for storing the plurality of advertisement stories from a plurality of advertisers, the ad network being a repository of advertisement stories that is dynamically updated based on the influx of advertisers and advertisement stories.

19. The system of claim 17, wherein the advertisement scheduler further including a ranking algorithm having a plurality of ranking parameters to rank and prioritize advertisement stories within the advertisement pool.

20. A method for optimally allocating ad space to advertisers on a webpage viewed by a user in a single browsing session, comprising:
identifying a plurality of advertisement stories based on content of the webpage, each of the plurality of advertisement stories associated with an ad value, each of the identified plurality of advertisement stories having an ad value greater than the ad value of an advertisement story currently rendered on the webpage, the pool of advertisement stories identified from an ad network, the ad network being a repository of advertisement stories from a plurality of advertisers that includes a variety of content;
generating a pool of advertisement stories using the identified advertisement stories;
selecting an advertisement story from the pool of advertisement stories upon dynamically evaluating ad value associated with each of the advertisement stories in the identified pool of advertisement stories based on continued surfing by the user; and
scheduling a rendering of the selected advertisement story at the webpage, the selected advertisement story providing higher ad revenue while providing relevant ad content at the webpage,
wherein each of the advertisement stories in the pool of advertisement stories include one or more advertisement pages.

21. The method of claim 20, wherein each of the advertisement page of an advertisement story associated with a distinct ad value, the ad value of the advertisement story reflecting the ad value of a corresponding advertisement page currently being considered for rendering when evaluating the ad value of the advertisement story.

22. The method of claim 20, wherein the pool of advertisement stories dynamically changes based on dynamic arrival of advertisement stories from a plurality of advertisers and on surfing strategy adopted by the user,
wherein the surfing strategy adopted by the user is one of continued surfing.

23. The method of claim 22, wherein the pool of advertisement stories includes the advertisement story currently rendered on the webpage.

24. The method of claim 23, wherein selecting an advertisement story further including,
determining a probability of continued surfing by the user; and
identifying an advertisement story from the generated pool of advertisement stories with a maximum ad value by comparing the ad value of each of the advertisement stories in the identified pool of advertisement stories based on the probability of continued surfing by the user.

25. The method of claim 24, wherein scheduling the rendering of the selected advertisement story further including,
interrupting the advertisement story currently rendered on the webpage;
scheduling rendering of a first advertisement page of the selected advertisement story, wherein the selected advertisement story is different from the advertisement story currently rendered on the webpage; and
discarding the remainder of the advertisement pages of the advertisement story currently rendered on the webpage from the pool of advertisement stories.

26. The method of claim 24, wherein scheduling the rendering of the selected advertisement story includes scheduling rendering of a subsequent advertisement page of the selected advertisement story, wherein the selected advertisement story is the advertisement story currently rendered on the webpage.

27. The method of claim 22, wherein upon completing rendering the highest ad value advertisement story, continuing rendering an advertisement story of next higher ad value based on the probability of user's continued surfing.
